(19) United States
(12) Patent Application Publication
(10) Pub. No.: US 2006/0283245 A1
(43) Pub. Date: Dec. 21, 2006

(54) VIBRATORY GYROSCOPE

(75) Inventors: Nobuaki KONNO, Tokyo (JP); Masahiro Tsugai, Tokyo (JP); Jun Fujita, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Chiyoda-ku (JP)

(21) Appl. No.: 11/423,281

(22) Filed: Jun. 9, 2006

(30) Foreign Application Priority Data
Jun. 16, 2005 (JP) 2005-176075
Feb. 23, 2006 (JP) 2006-046413

(51) Int. Cl. G01P 15/08

(52) U.S. Cl. 73/504.12

(57) ABSTRACT

According to one of the aspects of the present invention, a vibratory gyroscope includes a pair of proof masses having the same inertia mass, each of the proof masses having a first axis. The proof masses are arranged symmetrically in relation to a second axis. Also, the vibratory gyroscope includes a pair of drive elements, each of which has a driving axis extending in parallel to the second axis and supports respective one of the proof masses to allow oscillation thereof about the first axis. Further, the vibratory gyroscope includes a supporting element with an anchor element for supporting the drive elements to allow oscillation thereof about the driving axes. Finally, the vibratory gyroscope includes a main body having an inner space for receiving the supporting element, in which the main body is in contact with the anchor element of the supporting element and spaced away from the proof masses and the drive elements.

### BACKGROUND OF THE INVENTION

1) Technical field of the Invention

The present invention relates to a gyroscope, and in particular, to a vibratory gyroscope for detecting an angular velocity.

2) Description of Related Arts

One of examples of the vibratory gyroscope is described in the U.S. Pat. No. 4,598,585, which includes a sensing structure 510 as illustrated in FIG. 8. The sensing structure 510 includes a proof mass 512, a frame 514 for supporting the proof mass 512, and another frame 518 that has a pair of beams 516 extending along an X-axis and supporting the frame 514 at both sides thereof. The frame 518 is also supported by a component of the vibratory gyroscope (not shown), through another pair of beams 520 extending along a Y-axis perpendicular to the X-axis.

While the frame 518 oscillates about the beams 520, rotation at a given angular velocity 522 around the Z-axis that is perpendicular to the X- and Y-axes generates the Coriolis force to induce oscillation of the proof mass 512 about the beams 516. The amplitude of the induced oscillation about the beams 516 is proportional to the angular velocity 522. Therefore, the angular velocity 522 can be detected by measuring the amplitude of the induced oscillation.

In the meanwhile, the above-mentioned vibratory gyroscope may receive an external force (disturbance oscillation such as oscillating noise) which vibrates the sensing structure 510 along the Y-axis to oscillate the proof mass 512 about the beams 516, thereby resulting in improper detection of the angular velocity 522. In other words, the angular velocity detected by the conventional vibratory gyroscope may have adverse impact of the disturbance oscillation and less accuracy due to the external force.

Therefore, one of the aspects of the present invention is to provide the vibratory gyroscope that can precisely detect the angular velocity eliminating the adverse impact of the disturbance oscillation.

### SUMMARY OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the sprit and scope of the invention will become apparent to those skilled in the art from this detailed description.

According to one of the aspects of the present invention, a vibratory gyroscope includes a pair of proof masses having the same inertia mass, each of the proof masses having a first axis. The proof masses are arranged symmetrically in relation to a second axis. Also, the vibratory gyroscope includes a pair of drive elements, each of which has a driving axis extending in parallel to the second axis and supports respective one of the proof masses to allow oscillation thereof about the first axis. Further, the vibratory gyroscope includes a supporting element with an anchor element for supporting the drive elements to allow oscillation thereof about the driving axes. Finally, the vibratory gyroscope includes a main body having an inner space for receiving the supporting element, in which the main body is in contact with the anchor element of the supporting element and spaced away from the proof masses and the drive elements.

### BRIEF DESCRIPTION OF THE DRAWINGS

The present invention will more fully be understood from the detailed description given hereinafter and accompanying drawings which are given by way of illustration only, and thus are not limitative of the present invention.

FIG. 1 is a plan view of a vibratory gyroscope according to the first embodiment of the present invention.

FIG. 2 is a cross sectional view along a line of A-A of FIG. 1.

FIG. 3 is an enlarged view of FIG. 1 illustrating a layout of the sensing structure and internal electrodes.

FIG. 4 is an oblique view of the sensing structure of FIG. 3.

FIGS. 5A-5I are cross sectional views of the sensing structure of FIG. 1, showing the manufacturing process thereof.

FIG. 6 is a plan view of the vibratory gyroscope according to the second embodiment of the present invention.

FIG. 7 is a cross sectional view along a line of B-B of FIG. 6.

FIG. 8 is an oblique view of the sensing structure of the conventional vibratory gyroscope.

FIG. 9 is a plan view of the vibratory gyroscope according to the third embodiment of the present invention.

FIG. 10 is a cross sectional view along a line of C-C of FIG. 9.

FIG. 11 is an enlarged view of FIG. 9 illustrating a layout of the drive frame, the detection frame and the internal electrodes.

FIG. 12A is a plan view of a vibratory gyroscope. FIG. 12B is a cross sectional view along a line of D-D of FIG. 12A, showing the oscillating motion thereof while driving the oscillation of the frames. FIG. 12C is a cross sectional view along a line of E-E of FIG. 12A, showing the oscillating motion thereof while detecting the oscillation of the frames.

FIGS. 13A-13I are cross sectional views of the sensing structure of FIG. 9, showing the manufacturing process thereof.

FIGS. 14A-14D are oblique views of the sensing structure of FIG. 9, illustrating exemplary analysis of various oscillation modes.

FIGS. 15A-15D are oblique views of the sensing structure supported by a single beam, illustrating exemplary analysis of various oscillation modes.

FIGS. 16A and 16B are top plan view and side view of the drive frame supported by a single beam, FIGS. 16C and 16D are a plan view and a side view of the drive frame supported by two beams.

### DETAILED DESCRIPTION OF THE PREFERRED EMBODIMENTS

Referring to the attached drawings, the details of embodiment according to the present invention will be described herein. In those descriptions, although the terminology indicating the directions (for example, “X-(first)” “Y-(second)” and “Z-(third)” directions, each of which is perpendicular to the other) is conveniently used just for clarity, it should not be interpreted that those terminology limit the scope of the present invention.

### Embodiment 1

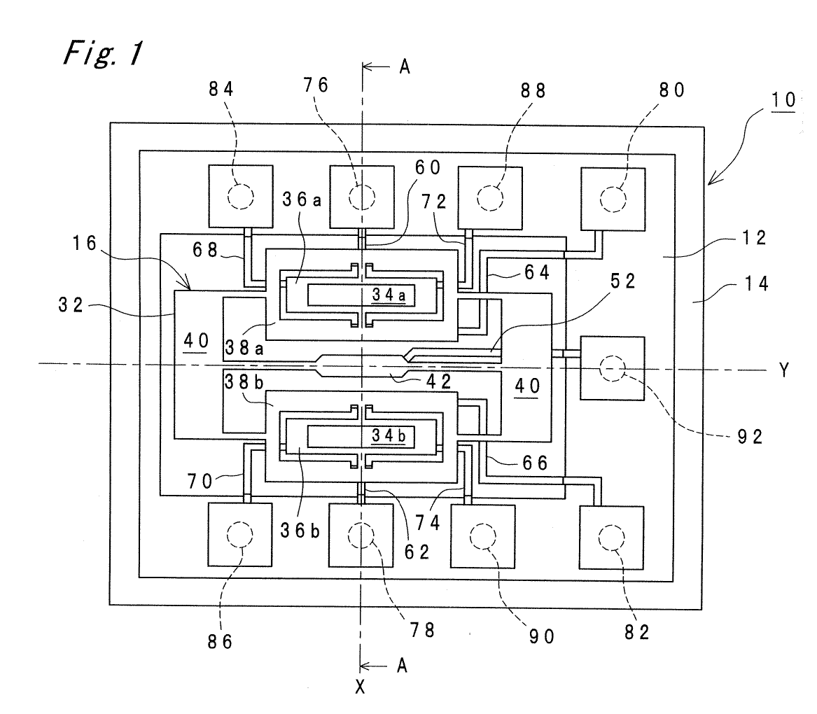

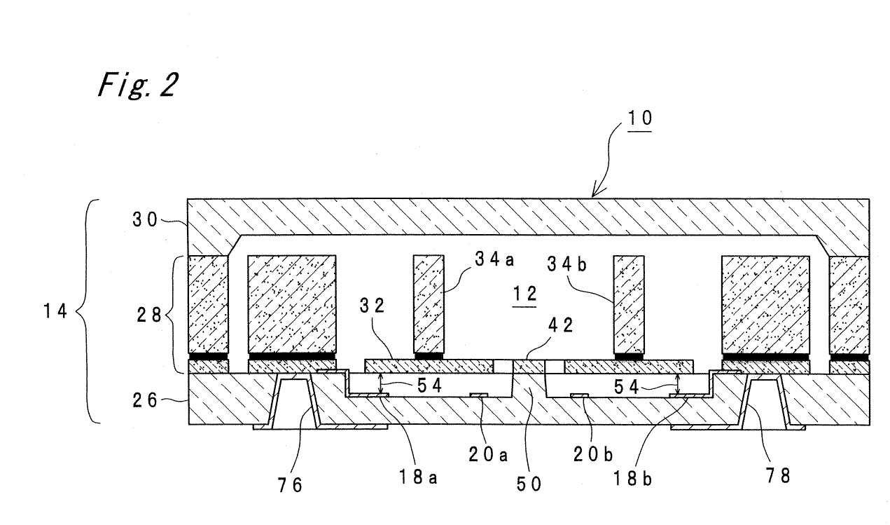

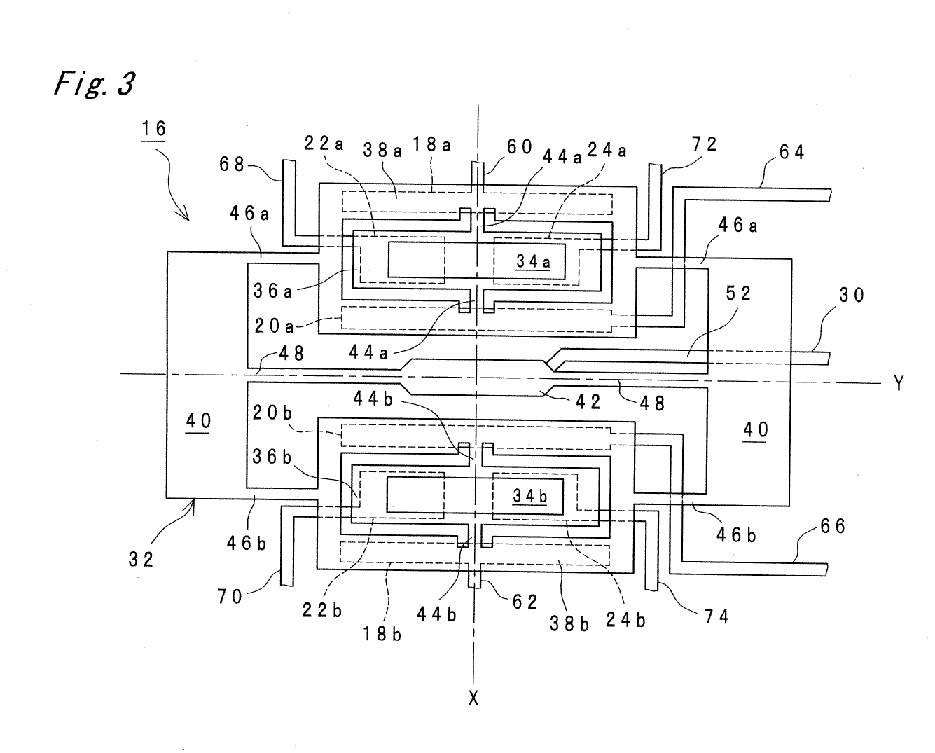

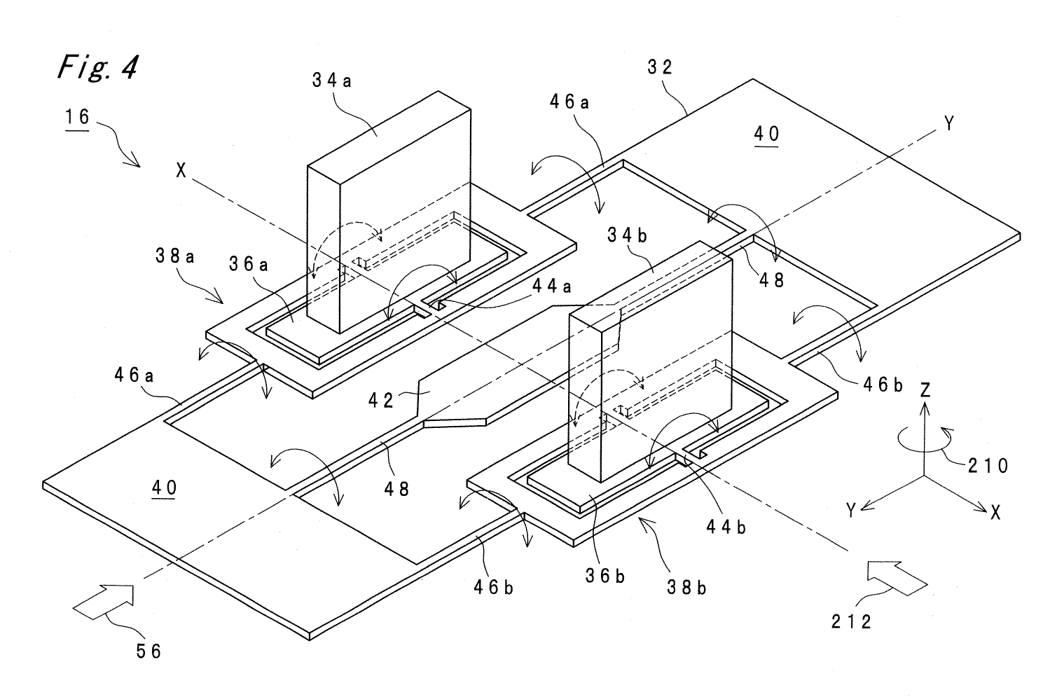

With reference to FIGS. 1-4, the first embodiment of the vibratory gyroscope will be described herein in detail. FIG. 1 is a plan view of the vibratory gyroscope. FIG. 2 is a cross sectional view along a line of A-A of FIG. 1. FIG. 3 is an enlarged view of a sensing structure illustrating a layout of internal electrodes as will be described later. FIG. 4 is an oblique view of the sensing structure.

The vibratory gyroscope generally denoted by reference numeral 10 is designed to detect the angular velocity around the Z-axis extending in the Z-direction, and includes a main body 14 defining a inner space 12 inside and a sensing structure 16 received within the inner space 12. Also, the vibratory gyroscope 10 includes a plurality of internal electrodes 18a, 18b, 20a, 20b 22a, 22b, 24a, 24b, which are provided with the main body 14 opposing to the sensing structure 16, for driving or detecting the oscillating motion of the sensing structure 16. Although not illustrated in the drawings, the vibratory gyroscope 10 further includes an oscillation driver for driving the sensing structure 16, an oscillation detector for detecting the oscillating motion of the sensing structure 16, and an angular-velocity calculator for calculating the angular velocity about the Z-axis based upon the oscillating motion detected by the oscillation detector.

The vibratory gyroscope of the first embodiment includes a pair of proof masses 34a, 34b having the same inertia mass, which are symmetrically arranged in relation to the Y-axis extending in the Y-direction. Each of the proof masses 34a, 34b is designed such that it can oscillate about the X-axis and also about the driving axis parallel to the Y-axis. The oscillation driver drives the proof masses 34a, 34b to oscillate about the driving axes parallel to the Y-axis at a predetermined frequency in the opposite phases to each other. In this condition, the induced oscillation of the proof masses 34a, 34b about the X-axis, which is induced by rotation (angular velocity) about the Z-axis, are detected by the oscillation detector so that the angular-velocity calculator calculates the angular velocity based upon the induced oscillation.

The structure and operation of the vibratory gyroscope of the first embodiment will be described herein in more detail. As illustrated in FIG. 2, the main body 14 includes a glass substrate 26 of a base, an enclosing wall 28 provided on the circumstance of the glass substrate 26 for defining the inner space 12, and a glass cap 30 for sealing the inner space 12.

As shown in FIG. 4, the sensing structure 16 includes a pair of the proof masses 34a, 34b having the same inertia mass, each of which is of a rectangular shape and mounted on a frame 32. The frame 32 is also configured symmetrically in relation to the X- and Y-axes. The frame 32 is received within the inner space 12 such that the principal surfaces of the frame 34 are perpendicular to the Z-axis of the inner space 12.

As illustrated in FIGS. 3 and 4, the frame 32 includes a pair of detection frames 36a, 36b for mounting the proof masses 34a, 34b, and a pair of drive frames 38a, 38b supporting the detection frames 36a, 36b via beams 44a, 44b at the sides thereof (referred to as “proof-mass supporting beams” or simply as “detection beams”), respectively. In this specification, the detection frame, the detection beams, and the proof mass may collectively be referred to simply as “proof mass”.

Also, the frame 32 includes a common frame 40 for supporting both of the drive frames 38a, 38b via beams 46a, 46b at the ends thereof (referred to as “drive-frame supporting beams” or simply as “drive beams”), respectively. In this context, the drive frame and the drive beams may collectively be referred to simply as “drive element”.

Further, the frame 32 includes a common frame 40 with a pair of beams 48 (referred to as “common-frame supporting beams” or simply to “common beams”), and an anchor 42 which is connected with the common frame 40 through the common beams 40 and seated on a frame supporting element 50 of the glass substrate 26. Thus, the common frame and the common beams for supporting the drive frames may collectively be referred to simply as “supporting element”.

Thanks to the frame 32 so embodied, the main body 14 supports the frame 32 through the anchor 42 within the inner space 12 so as to allow the oscillation of the detection frames 36a, 36b about the detection beams 44a, 44b and the drive frames 38a, 38b about the drive beams 46a, 46b.

In general, the oscillation of the proof masses 34a, 34b on the detection frames 36a, 36b about the detection beams 44a, 44b is monitored to detect the angular velocity about the Z-axis in a manner as will be described after describing the structure of the vibratory gyroscope 10. It should be noted that the detection frames 36a, 36b may be regarded as portions of the proof masses 34a, 34b because they move together therewith. Alternatively, the proof masses 34a, 34b may have depth in the Z-direction that is substantially zero and only the detection frames 36a, 36b contribute to the inertia mass, to which the present invention is equally applied. Each of the detection frames 36a, 36b has a shape (rectangular shape in the present embodiment) that is symmetrical relative to the X-axis to the other.

As will be described later, the drive frames 38a, 38b are driven by the oscillation driver for oscillation about the drive beams 46a, 46b. As illustrated in FIG. 3, the drive frames 38a, 38b each have a planer shape (a rectangular shape in the present embodiment) that are symmetrical relative to the X-axis, surrounding the detection frames 36a, 36b to support them via the detection beams 44a, 44b at the sides thereof, respectively. The detection beams 44a, 44b for connection between the drive frame and the detection frame extend along the X-axis.

The detection beams 44a, 44b are designed such that the detection frames 36a, 36b torsionally oscillate relative to the drive frames 38a, 38b about the detection beams 44a, 44b. In this specification, the torsional oscillation about the beam may refer to the cyclic oscillation with angular displacement varying in a predetermined range about the longitudinal axis of the beam, which is biased by the torsional counterforce of the beam.

Also, as shown in FIG. 3, the drive frames 38a, 38b are arranged symmetrically on either side of the Y-axis, and supported by the common frame 40 at the ends thereof through the drive beams 46a, 46b, respectively.

Similar to the detection beams 44a, 44b, the drive beams 46a, 46b are also designed such that the drive frames 38a, 38b torsionally oscillate relative to the common frame 40 about the drive beams 46a, 46b.

Further, as shown in FIG. 3, the anchor 42 is positioned at the intersection of the X-axis and the Y-axis, i.e., at the center of the frame 32, and supported by the common frame 40 through the common beams 48. Also, as illustrated in FIG. 2, the anchor 42 is seated and supported on the frame supporting element 50 which protrudes from the glass substrate 26 of the main body 14. Thus, the sensing structure 16 (the frame 32) with exception of the anchor 42 is kept spaced from the main body 14 within the inner space 12. In other words, in the sensing structure 16, the anchor 42 of the frame 32 is the only portion that contacts with the other components of the vibratory gyroscope 10. The reason that the sensing structure is supported by the main body 14 will be apparent from the following description.

When shape and configuration of the drive frames 38a, 38b and the drive beams 46a, 46b supporting thereof are ideally identical to each other, upon application of a driving method as will be described later, the drive frames 38a, 38b oscillate about the drive beams 46a, 46b at a resonance frequency in the opposite phases to each other where the relative phase shift is 180 degrees (so-called tuning-fork oscillation).

However, in practical, the configuration thereof such as shapes of the drive beams 46a, 46b, sizes and weights of the drive frames 38a, 38b are slightly varied and unbalanced to each other due to the manufacturing tolerance. This causes the deviation between the resonance frequencies determined by the drive frame 38a, 38b and the beam 46a, 46b supporting thereof, respectively. Thus, when the drive frames 38a, 38b are driven to oscillate at the resonance frequency of one of the drive frames, the other one of the drive frames may oscillate with the phase shift deviated from the opposite phase of one of the drive frames.

The common beams 48 are designed such that both of the drive frames 38a, 38b torsionally oscillate at the resonance frequency in the opposite phases without deviating therefrom, even if those frames and the beams supporting thereof have configuration and shape different from each other due to the manufacturing tolerance. In particular, the common beams 48 have torsional rigidity, cross section, and length designed to achieve the torsional oscillation of the drive frames 38a, 38b at the resonance frequency in the opposite phases. Thus, provision of the common beams 48 supporting the common frame 40 achieves the robust tuning-fork oscillation system that can oscillate at the common resonance frequency in the opposite phases in spite of the minor manufacturing tolerance.

The frame 32 is made of conductive material and electrically connected to the ground potential (or a predetermined biasing potential) via a wiring 52.

Each of the internal electrodes 18a, 18b, 20a, 20b, 22a, 22b, 24a, 24b has a main surface opposing and in parallel to the frame 32 of the sensing structure 16 (see FIG. 2). The layout and the function of the internal electrodes will be described hereinafter.

The internal electrodes 18a, 18b each are arranged on the glass substrate 26 opposing to and along the outer one of the sides (one side away from the anchor 42) of the drive frames 38a, 38b, which are applied with a given oscillation voltage (having AC voltage component on DC voltage component). The oscillation voltage effects an electrostatic force 54 between the internal electrodes 18a, 18b and the outer sides of the drive frames 38a, 38b (FIG. 2), which in turn drives the drive frames 38a, 38b for oscillation about the drive beams 46a, 46b in the opposite phases, respectively. For instance, when viewing from the direction as indicated by an arrow 56 of FIG. 4, the drive frame 38a torsionally oscillates about the drive beam 46a in a counterclockwise direction, while the drive frame 38b torsionally oscillates about the drive beam 46b in a clockwise direction. The torsional oscillation frequency corresponds to the frequency of the oscillation voltage, which is selected to be one of the resonance frequency of the oscillation system, allowing the resonance oscillation in the opposite phases.

Also, the internal electrodes 20a, 20b each are arranged on the glass substrate 26 opposing to and along the inner one of the sides (one side close to the anchor 42) of the drive frames 38a, 38b, for detecting the oscillation of the drive frames 38a, 38b about the drive beams 46a, 46b in the opposite phases, respectively. The internal electrodes 20a, 20b each define capacitance in conjunction with the drive frames 38a, 38b biased at the ground level, respectively. The capacitance varies in response to the oscillating motion (displacement) of the drive frames 38a, 38b, where the capacitance variation depends upon the variation of the oscillation amplitude of the drive frames 38a, 38b about the drive beams 46a, 46b. As above, while the oscillation driver of the vibratory gyroscope 10 drives the drive frames 38a, 38b for oscillation about the drive beams 46a, 46b in the opposite phases, the oscillation driver adjusts the oscillation frequency applied to the internal electrodes 18a, 18b based upon the detected capacitance (self-oscillation). The capacitance variation may be detected, for example, by a C/V (capacitance/voltage) converter (not shown). Also, the oscillation driver adjusts the oscillation voltage applied to the internal electrodes 18a, 18b so as to keep the oscillation amplitude substantially constant.

Also, two pairs of the internal electrodes 22a, 24a; 22b, 24b are arranged on the glass substrate 26 opposing to the detection frame 36a, 36b for detecting the motion, i.e., the oscillating motion about the detection beams 44a, 44b, of the detection frames 36a, 36b, respectively. As illustrated in FIG. 3, the internal electrodes 22a, 24a are symmetrically arranged relative to the X-axis, and also the internal electrodes 22b, 24b are symmetrically arranged relative to the X-axis. Similar to the detection of the oscillation about the drive beams 46a, 46b, the oscillation variation about the detection beams 44a, 44b are detected by the capacitance variation between the detection frames 36a, 36b and the internal electrodes 22a, 24a; 22b, 24b, respectively, which are converted to voltage variation detected by the C/V converter.

The internal electrodes 18a, 18b, 20a, 20b, 22a, 22b, 24a, 24b are electrically connected with the external electrodes through the wirings 60, 62, 64, 66, 70, 72, 74, respectively. For example, as shown in FIG. 2, the internal electrodes 18a, 18b are electrically connected with the external electrodes 76, 78 via a silicon layer, respectively. Like this, other internal electrodes 20a, 20b, 22a, 22b, 24a, 24b are electrically connected with the external electrodes 80, 82, 84, 86, 88, 90, respectively. The external electrodes 76, 78, 80, 82 from the internal electrodes 18a, 18b, 20a, 20b extend to the oscillation driver for electrical connection, while the external electrodes 84, 86, 88, 90 from the internal electrodes 22a, 22b, 24a, 24b are electrically connected with the oscillation driver.

The wiring 52 for biasing the frame 32 of the sensing structure 16 to the ground level is electrically connected with the external electrode 92.

As described above, the oscillation driver is designed so as to apply a predetermined oscillation voltage to the internal electrodes 18a, 18b. Also, the oscillation detector detects the oscillation of the detection frames 36a, 36b based upon the voltage output from the C/V converter which detects the capacitance variation between the detection frames 36a, 36b and the internal electrodes 22a, 22b; 24a, 24b, respectively. Also, as will be described later, an angular-velocity calculator is provided for receiving the voltages corresponding to the detected oscillation of the detection frames 36a, 36b about the detection beams 44a, 44b.

The angular-velocity calculator calculates or detects the angular velocity based upon the voltages corresponding to the oscillation of the detection frames 36a, 36b about the detection beams 44a, 44b detected by the oscillation detector, which varies in response to the rotation of the vibratory gyroscope 10 around the Z-axis of the angular velocity, as will be described later.

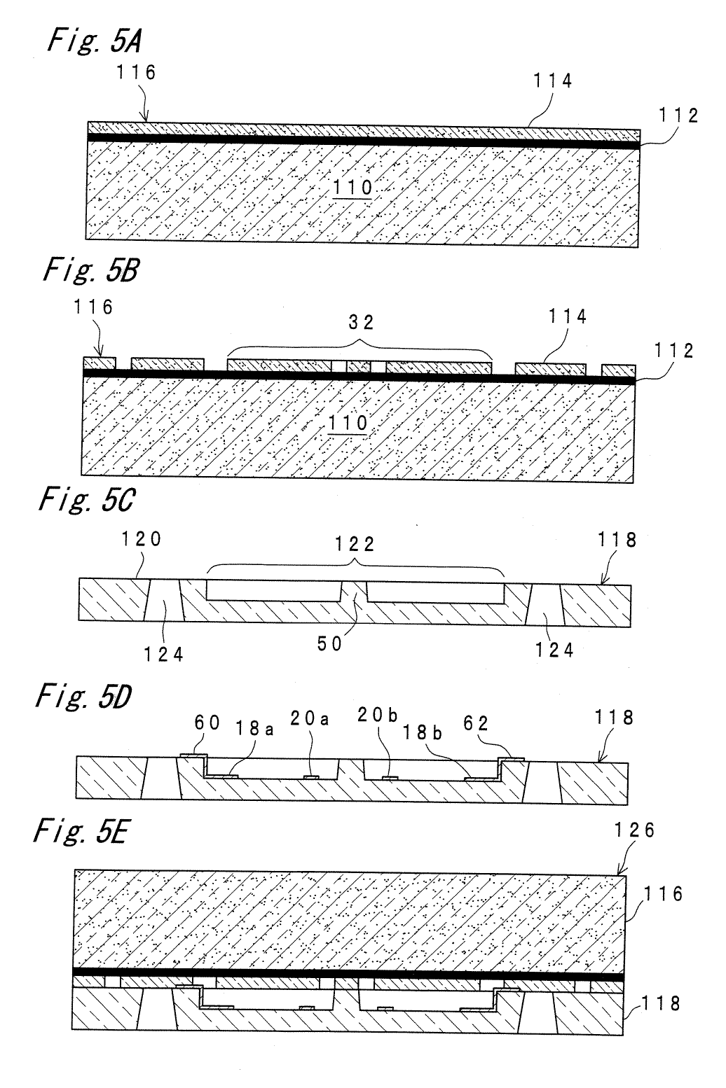

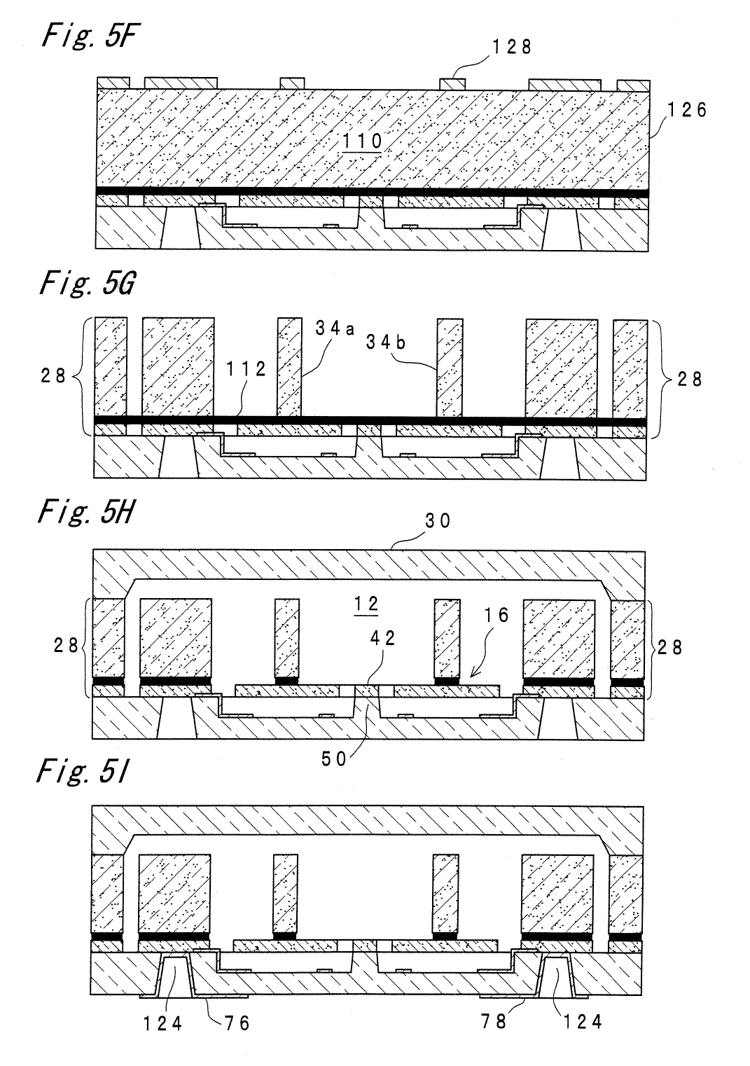

Next, referring to FIGS. 5A-5I, the manufacturing process of the vibratory gyroscope 10 will be described herein. FIGS. 5A-5I are cross sectional views illustrating various steps for manufacturing the vibratory gyroscope 10 of the present embodiment.

Firstly, as shown in FIG. 5A, a SOI (Silicon-On-Insulator) wafer 116 as one component is prepared or produced, including a wafer substrate 110 that has an oxide layer 112 thereon of thickness of several microns and a silicon active layer 114 on the oxide layer 112.

As shown in FIG. 5B, the silicon active layer 114 is selectively etched. The silicon active layer 114, which remains without being etched, forms the above-described various frames of the completed sensing structure 16 of the vibratory gyroscope 10.

On the other hand, as shown in FIG. 5C, another component 118 of the vibratory gyroscope 10 is prepared. A glass substrate 120 (corresponding to the glass substrate 26 of the vibratory gyroscope 10) is processed by means of any conventional technique such as etching and ultrasonic machining to form recessed portions 122, remaining the supporting element 50 that contact with the anchor 42 of the sensing structure 16. Thus, the recessed portions 122 allows the frame 32 to be contacted with and supported by only the supporting element 50 of the glass substrate 26. Also, a plurality of through-holes 124 are formed by the same technique, on each of which the respective one of external electrodes 76, 78, 82, 84, 86, 88, 90, 92 is formed.

As shown in FIG. 5D, the internal electrodes 18a, 18b, 20a, 20b are formed by arranging the wirings 60, 62 on the glass substrate 120 at predetermined positions. Although not specifically illustrated, the other internal electrodes 22a, 22b, 24a, 24b and the other wirings 52, 64, 66, 70, 72, 74 are also formed on the glass substrate 120 at predetermined positions. The internal electrodes may be formed by selectively sputtering or depositing metal such as aluminum or gold.

As shown in FIG. 5E, the SOI wafer 116 is bonded on the components 118 with the main surface of the silicon active layer 114 facing to the recessed portion 122 of the glass substrate 120. The components 116, 118 may be bonded by means of any conventional techniques such as an anodic bonding.

After forming the component 126 by bonding the components 116, 118, the upper surface of the wafer substrate 110 is polished to have predetermined thickness, and then an etching mask 128 is formed on the selective regions of the wafer substrate 110 as shown in FIG. 5F.

As illustrated in FIG. 5G, the wafer substrate 110 is selectively etched with the etching mask 128. The portions that are remained without being etched define the proof masses 34a, 34b and the enclosing wall 28 of the vibratory gyroscope 10.

Next, as shown in FIG. 5H, the exposed oxide layer 112 are removed by hydrofluoric acid (HF) or buffered hydrofluoric acid (BHF). This separates the sensing structure 16 from the other components of the vibratory gyroscope 10 with exception of the anchor 42. Then, a glass cap 30 is bonded on the enclosing wall 28 to define the inner space 12 by means of the anodic bonding.

As shown in FIG. 5I, the external electrodes 76, 78 are formed on the through-holes 124. Although not shown, each of the other external electrodes 80, 82, 84, 86, 88, 90 is formed on the respective one of the through-holes 124. The external electrodes may be made of the same metal as one of the internal electrodes. To this end, the main body 14 of the vibratory gyroscope 10 is produced in accordance with the above-described manufacturing process.

The proof masses 34a, 34b produced by the manufacturing process have the center of mass, which is far away from the X-Y plane, so that the drive frames 38a, 38b are driven to oscillate about the drive beams 46a, 46b with increased oscillation amplitude. This increases the oscillation amplitude of the detection frames 36a, 36b about the detection beams 44a, 44b thereby to improve the detection sensitivity of the gyroscope.

To achieve the center of mass of the proof masses 34a, 34b farther from the X-Y plane, the wafer substrate 110 should be thicker allowing the proof masses 34a, 34b to be taller. The thicker wafer substrate 110 may selectively be etched, preferably by means of a deep etching technique, e.g., a ICP-RIE (Inductive Coupled Plasma—Reactive Ion Etching) technique.

Another approach to improve the detection sensitivity of the gyroscope 10 is eliminating the proof masses 34a, 34b, and increasing surface area and thickness of the drive frames 38a, 38b and the detection frames 36a, 36b in the X-Y plane. The manufacturing process would be simpler than the above process. A wafer substrate 110 is used, instead of the SOI wafer 116 as the initial component. The wafer substrate 110 is processed with the same manufacturing process as shown in FIGS. 5A-5I, however, no step for removing the dioxide layer 112 is required for producing the vibratory gyroscope 10.

Next, with reference to the drawings, the operation of the vibratory gyroscope 10 of the present embodiment will be described herein.

Referring back to FIG. 4, according to the sensing structure 16 of the vibratory gyroscope 10, the oscillation driver applies the oscillation voltage of a predetermined frequency to the internal electrodes 18a, 18b (FIG. 3), for oscillating the drive frames 38a, 38b about the drive beams 46a, 46b, respectively, in the opposite phases to each other. In this situation, upon rotation of the vibratory gyroscope 10 around the Z-axis at the angular velocity 210, the Coriolis force is generated to induce the oscillation of the proof masses 34a, 34b (and the detection frames 36a, 36b) about the detection beams 44a, 44b. Coriolis force is proportional to the angular velocity 210 around the Z-axis of the proof mass and corresponds to the driving oscillation of the drive frame. Therefore, the induced oscillation of the detection frames 36a, 36b have the maximum amplitude in proportional to the angular velocity, and also have the frequency and the phase same as those of the drive frames 38a, 38b, respectively. Thus, the detection frames 36a, 36b are induced to oscillate at the resonance frequency in the opposite phases to each other. When viewing from the direction indicated by the arrow 212, for example, the proof mass 34a torsionally oscillates about the detection beam 44a in a counterclockwise direction, while the proof mass 34b torsionally oscillates about the detection beam 44b in a clockwise direction.

The induced oscillation about the detection beams 44a, 44b vary the capacitance between the detection frame 36a and the internal electrodes 22a, 24a, and between the detection frame 36b and the internal electrodes 22b, 24b. As the capacitance between the detection frame 36a and the internal electrode 22a increases, the capacitance between the detection frame 36a and the internal electrode 24a decreases, thus, the capacitance between the detection frame 36a and the internal electrodes 22a, 24a vary in the opposite phases to each other. Such capacitance variation is detected by the C/V converter, which in turn outputs the voltage indicating the capacitance variation.

The voltages, which are output from the C/V converter indicating the capacitance variation between the detection frame 36a and the internal electrodes 22a and between the detection frame 36b and the internal electrodes 22b, are referred to as the voltages Va, Vb, respectively. Since the proof masses 34a, 34b are induced to oscillate about the detection beams 44a, 44b in the opposite phases, the voltages Va, Vb has a relationship as Va=−Vb. (Strictly speaking, the circuitry is also designed such that the polarity of the voltages Va, Vb are opposite to each other.) Therefore, for example, by electrically connecting the internal electrodes 622a, 624b diagonally, the oscillation detector of the vibratory gyroscope 10 can output the voltage signal of Vout (=Va−Vb=2×Va=−2×Vb) to the angular-velocity calculator. Thus, double detection sensitivity can be obtained in comparison with the conventional vibratory gyroscope. Also, since the noise components in the same phase of the voltages Va, Vb are offset to each other, the signal-noise (S/N) ratio of the detection signal is improved. The angular-velocity calculator calculates the angular velocity of the vibratory gyroscope 10 based upon the phase of the driving oscillation and the voltage amplitude Vout of the induced oscillation. Therefore, the vibratory gyroscope 10 can precisely calculate the angular velocity at high sensibility, reducing the adverse effects of the disturbance oscillation.

One of examples showing elimination of the impact due to the disturbance oscillation will be described herein. When the vibratory gyroscope 10 receives the external force (disturbance oscillation) along the direction parallel to the Y-axis and/or the torsional oscillation about the X-axis, the proof masses 34a, 34b oscillate about the detection beams 44a, 44b, respectively, in the same phase. Thus, when viewing from the direction indicated by the arrow 212, both of the proof masses 34a, 34b torsionally oscillate about the detection beams 44a, 44b in a counterclockwise direction, for example. Then, the voltages Va, Vb have the relationship, i.e., Va=Vb. Therefore, the voltage output from the oscillation detector is zero (0) volt. As above, the vibratory gyroscope 10 is designed such that the proof masses 34a, 34b are induced to oscillate about the detection beams 44a, 44b in the opposite phases, and the disturbance oscillation can hardly generate the induced oscillation in the opposite phases. Therefore, the angular velocity can precisely be detected, eliminating the possibility of improper detection.

It should be noted that since the disturbance oscillation induces the oscillation in the same phase, the disturbance oscillation (acceleration along the Y-axis) can be detected by summing the oscillation components induced by the disturbance oscillation. In this instance, an acceleration calculator is required for calculating the acceleration based upon the voltage output from the oscillation detector. However, in case where the proof masses 34a, 34b has depth in the Z-direction that is substantially zero, since no oscillation about the detection beams 44a, 44b in the same phase is caused by the acceleration along the Y-axis, the acceleration along the Y-axis cannot be detected. Including this case and the case where the acceleration is not required to be detected, the torsional oscillation of the proof masses 34a, 34b are not required to separately be detected by the respective one of oscillation detectors. Rather, the internal electrodes 22a, 24b and the internal electrodes 22b, 24a may be electrically connected on the glass substrate, and a single oscillation detector is used for detecting the capacitance variation caused by the torsional oscillation due to the Coriolis force. This facilitates reduction of the C/V converters in number, and as well as the wirings and external electrodes in number, thereby downsizing the sensing structure 16 and manufacturing it at a more reasonable cost.

### Embodiment 2

In the first embodiment, the drive frames are driven to oscillate by applying the voltage between the wiring internal electrodes and the bottom surface of the drive frames facing thereto, i.e., by generating the electrostatic force between two planes having a gap substantially varying in response to the amplitude (phase) of the driving oscillation. It is clear that any other components rather than the internal electrodes can be used for generating electrostatic force in cooperation with the drive frame, as far as it is parallel to the drive frame.

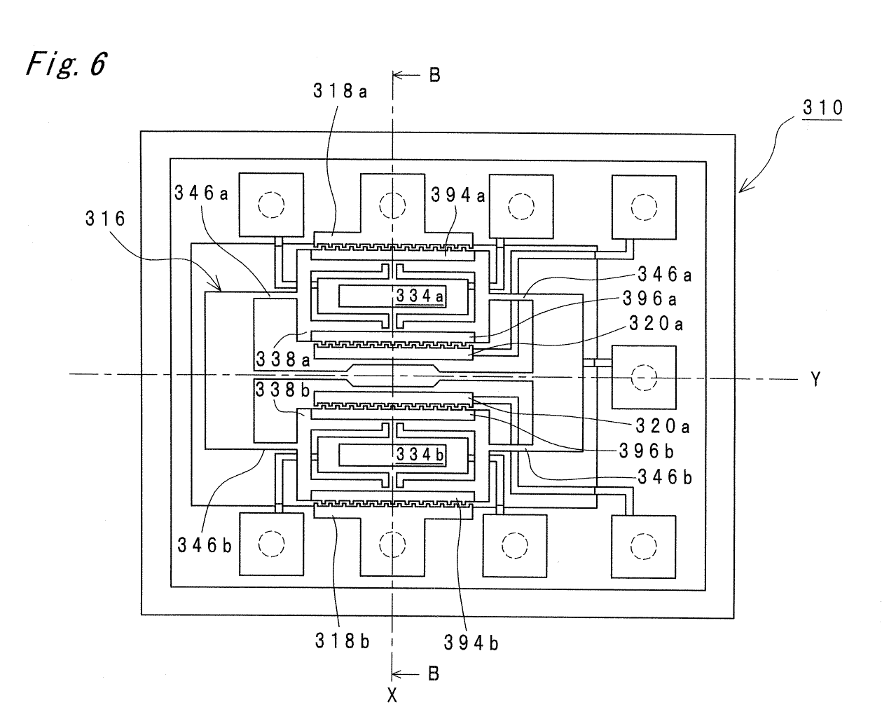

For example, according to the second embodiment, the vibratory gyroscope illustrated in FIG. 6 includes comb electrodes 318a, 318b, each having the planner comb-like configuration when viewing from the direction along the Z-axis, instead of the internal electrodes 18a, 18b as described above, for oscillating the drive frames 338a, 338b about the drive beams 346a, 346b. Also, the vibratory gyroscope 310 includes comb electrodes 320a, 320b instead of the internal electrodes 20a, 20b, for detecting the driving oscillation about the drive beams 346a, 346b in the opposite phases.

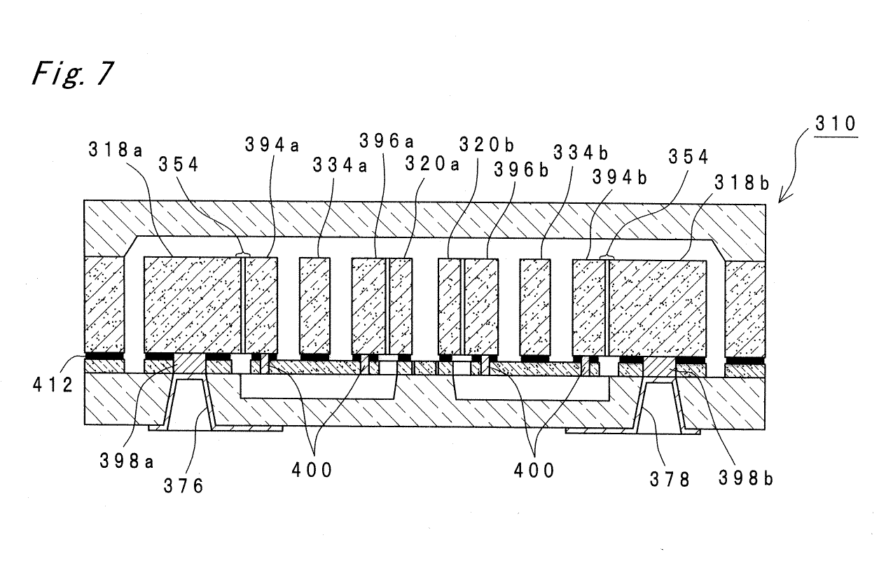

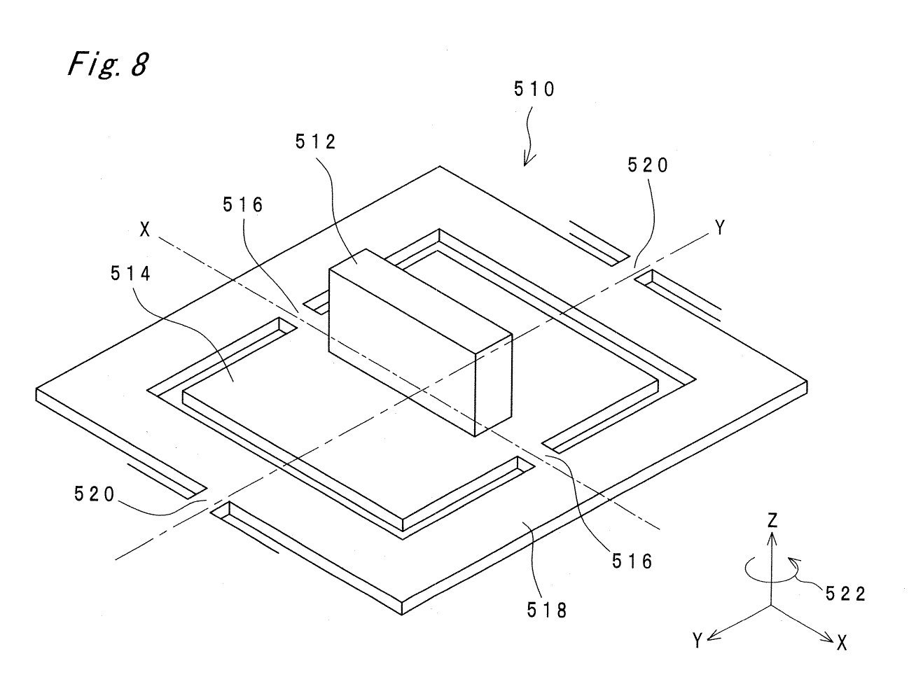

FIG. 7 is a cross sectional view along a line of B-B of FIG. 6. Also, arranged on the drive frames 338a, 338b are comb structures 394a, 394b, each also having the planner comb-like configuration when viewing from the direction along the Z-axis. The comb structures 394a, 394b opposes to the comb electrodes 318a, 318b with a gap formed therebetween, in which the electrostatic force is generated by applying the voltage therebetweeen for oscillation the drive frames 338a, 338b. Further, arranged on the drive frames 338a, 338b are comb structures 395a, 396b, opposing to the comb electrodes 320a, 320b, for generating capacitance in cooperation with the comb electrodes 320a, 320b. The capacitance variation is used for detecting the driving oscillation about the drive beams 346a, 346b in the opposite phases.

The vibratory gyroscope 310 of the second embodiment may be manufactured by the process similar to that of the first embodiment, and the comb electrodes 318a, 318b, 320a, 320b and the comb structures 394a, 394b, 396a, 396b are formed of the wafer substrate at the same time for producing the proof masses 334a, 334b, thereby to be isolated one another by an insulating layer 412. Therefore, the comb electrodes 318a, 318b are electrically connected with the external electrodes 376, 378 via conductive elements 398a, 398b, respectively. Also, the comb structures 394a, 394b, 395a, 396b are electrically connected with the frame 332 via the conductive elements 400. Other components of the vibratory gyroscope 310 of the present embodiment are similar to those of the first embodiment.

The oscillation voltage applied to the comb electrodes 318a, 318b generates the electrostatic force between the comb electrodes 318a, 318b and the comb structures 394a, 394b, which torsionally oscillates the drive frames 338a, 338b about the drive beams 346a, 346b. The amplitude of the driving oscillation of the drive frames 338a, 338b can be increased in comparison with that of the first embodiment, because the electrostatic force between the comb electrodes and the comb structures is kept substantially constant regardless the inter-electrode distance, while the electrostatic force is in principle stronger as the inter-electrode distance is smaller. Also, in the first embodiment, the drive frames 38a, 38b may contact with the internal electrodes 18a, 18b if the distance therebetween is too small. In other words, the distance between the drive frame and the internal electrode cannot be reduced less than a given distance in the first embodiment. Meanwhile, the electrostatic force is substantially constant in the present embodiment, the amplitude of the driving oscillation can be increased just before the comb structures 394a, 394b contact the comb electrodes 318a, 318b. Therefore, according to the second embodiment, the amplitude of the driving oscillation is greater than that of the first embodiment, so that the vibratory gyroscope improves the detection sensitivity in comparison with the first embodiment.

Also, according to the sensing structure of the present embodiment, since the electrostatic force is substantially constant regardless the distance from between the comb electrodes 318a, 318b and the comb structures 394a, 394b, the controllability of the driving oscillation is improved.

It should be noted that in the manufacturing process of the vibratory gyroscope of the first embodiment, the bonding ability (feature) of the anodic bonding can be enhanced by electrical connection between the wafer substrate and the active layer 114 through the conductive portions 398a, 398b and the conductive portions 400.

Therefore, according to the second embodiment, the controllability of the driving oscillation can be improved and the angular velocity can be detected at the enhanced detection sensitivity.

### Embodiment 3

The vibratory gyroscope according to the third embodiment of the present invention has a structure similar to those of the first and second embodiments, except that each of the frames has one side (or end) having a plurality of beams extending therefrom for supporting the frame for oscillation.

In particular, according to the vibratory gyroscope of the third embodiment, a pair of torsion beams extending in parallel is provided for connection between the detection frame and the drive frame, and between the drive frame and the common frame, thereby supporting the detection frame and the drive frame. Therefore, the vibratory gyroscope likely eliminates the impact of the disturbance oscillation especially characterized by lower oscillation frequency than those of the torsional oscillation of the drive frames and detection frames, and the other oscillation modes similar thereto.

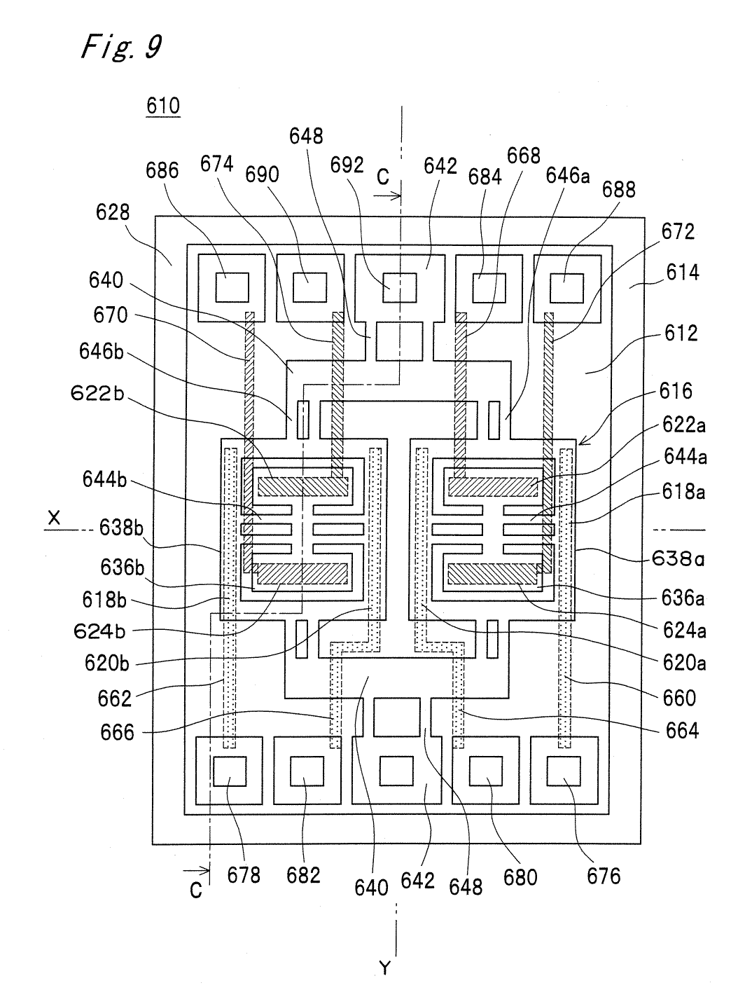

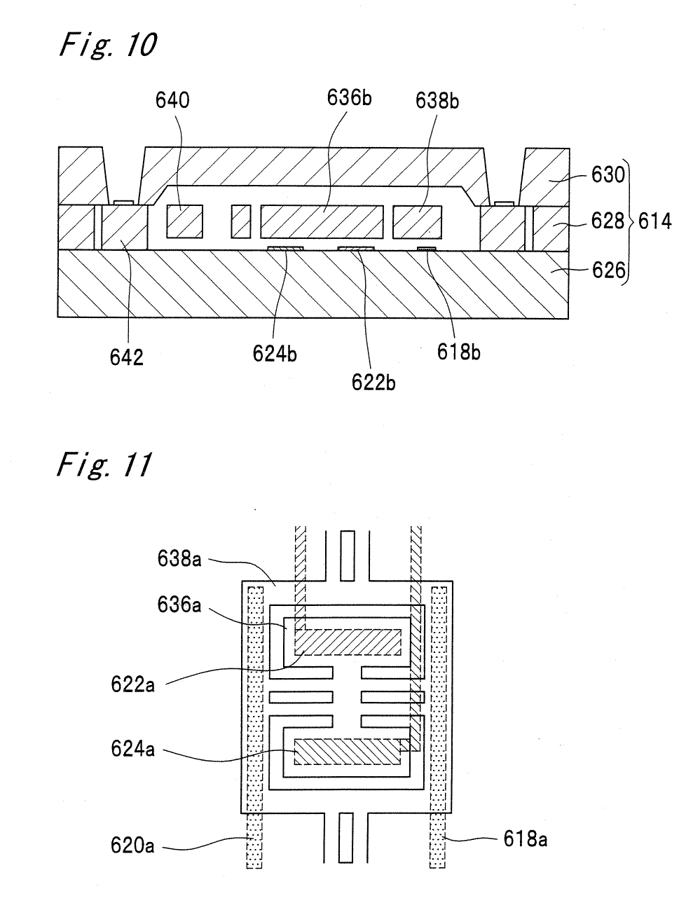

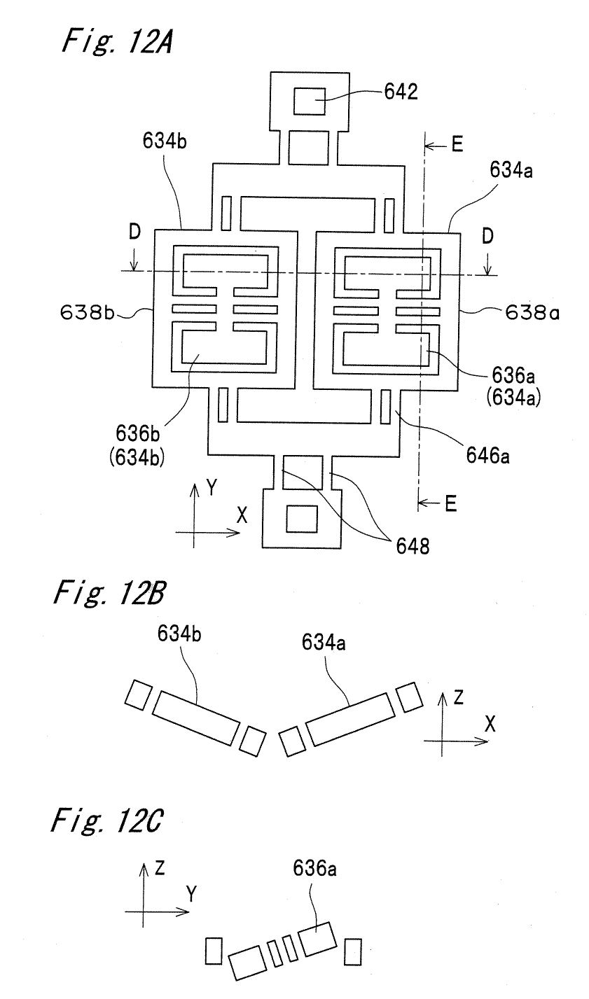

Referring to FIGS. 9 to 12A-12C, the vibratory gyroscope of the third embodiment will be described in detail hereinafter. FIG. 9 is a plan view of the vibratory gyroscope. FIG. 10 is a cross sectional view along a line of C-C of FIG. 9. FIG. 11 is an enlarged view of FIG. 9, showing the layout of the internal electrodes as will be described later. FIG. 12A is a plan view of a vibratory gyroscope. FIG. 12B is a cross sectional view along a line of D-D of FIG. 12A, showing the oscillating motion thereof while driving the oscillation of the frames. FIG. 12C is a cross sectional view along a line of E-E of FIG. 12A, showing the oscillating motion thereof while detecting the oscillation of the frames. The X-, Y-, Z-axis are used to refer to the axes same as those of the first and second embodiments, each of which is perpendicular to the others.

As illustrated in FIG. 9, the vibratory gyroscope generally denoted by reference numeral 610 includes a main body 614 defining an internal space 612 inside and a sensing structure 616 arranged so as to allow oscillation within the internal space 612. Also, as shown in FIGS. 10 and 11, the vibratory gyroscope generally includes a plurality of internal electrodes 618a, 618b, 620a, 620b, 622a, 622b, 624a, 624b provided with the main body 614, for driving and detecting the operation of the sensing structure 616. Although not illustrated in the drawings, the vibratory gyroscope 610 further includes an oscillation driver for driving the sensing structure 616, an oscillation detector for detecting oscillating motion of the sensing structure 616, and an angular-velocity calculator for calculating the angular velocity about the Z-axis based upon the oscillation detected by the oscillation detector.

According to the vibratory gyroscope of the third embodiment, the proof masses 634a, 634b consist of the detection frames 636a, 636b, respectively. The proof masses 634a, 634b are arranged symmetrically relative to the Y-axis. Each of the proof masses 634a, 634b is designed such that it can oscillate about the X-axis and also about the driving axis parallel to the Y-axis. The oscillation driver drives the proof masses 634a, 634b to oscillate about the driving axes parallel to the Y-axis at a predetermined frequency in the opposite phases to each other. In this condition, the induced oscillation of the proof masses 34a, 34b about the X-axis, which is induced by rotation (angular velocity) about the Z-axis, are detected by the oscillation detector so that the angular-velocity calculator calculates the angular velocity based upon the induced oscillation.

The structure and operation of the vibratory gyroscope 610 of the third embodiment will be described herein in more detail. As illustrated in FIG. 10, the main body 614 includes a glass substrate 626 of a base, an enclosing wall 628 provided on the circumstance of the glass substrate 626 for defining the inner space 612, and a glass cap 630 for sealing the inner space 612.

As illustrated in FIGS. 9 and 10, the sensing structure 616 includes a pair of detection frames 636a, 636b consisting of the proof masses 634a, 634b, and a pair of drive frames 638a, 638b supporting the detection frames 636a, 636b via the detection beams 644a, 644b at the sides thereof, respectively. Also, the sensing structure 616 includes a common frame 640 for supporting both of the drive frames 638a, 638b via the drive beams 646a, 646b at the ends thereof, respectively. Further, the sensing structure 616 includes the common frame 640 having two pairs of common beams 648 on both ends of the common frame 640, and a pair of anchors 642 arranged close to both ends of the common frame 640, which are connected with the common frame 640 through the common beams 640 for supporting thereof.

The description will be made for the manner how to detect the angular velocity around the Z-axis based upon the oscillating motion of the detection frames 636a, 636b. As illustrated in FIG. 11, the detection frames 636a, 636b of the third embodiment are of H-shaped configuration and arranged symmetrically in relation to the X-axis.

The drive frames 638a, 638b are driven by the oscillation driver for oscillation about the drive beams 646a, 646b. As illustrated in FIG. 11, the drive frames 638a, 638b each have a planer shape (a rectangular shape in the present embodiment) that are symmetrical relative to the X-axis, surrounding the detection frames 636a, 636b to support them via the detection beams 644a, 644b at the sides thereof, respectively.

According to the third embodiment, unlike the foregoing embodiments, a plurality of pairs (two sets) of the detection beams 644a, 644b are provided, extending in the direction parallel to the X-axis, so that the detection frames 636a, 636b each torsionally oscillate about detection oscillation center axis provided in the middle of the detection beams 644a, 644b, respectively. It should be noted that although two detection beams are used for describing and illustrating the third embodiment, the present invention may equally be adapted to the case where three or more detection beams are used. In those cases, the oscillation center would be right middle between two of the outer detection frames.

Also, as shown in FIG. 9, the drive frames 638a, 638b are arranged symmetrically on either side of the Y-axis, and supported by the common frame 640 at the ends thereof through the paired drive beams 646a, 646b, respectively.

Similar to the detection beams 644a, 644b, a plurality of pairs (two sets) of the drive beams 646a, 646b are provided, extending in the direction parallel to the Y-axis, so that the drive frames 638a, 638b each torsionally oscillate about drive oscillation center axes provided in the middle of the drive beams 646a, 646b, respectively.

Further, as shown in FIG. 9, each of the anchors 642 is positioned and connected to the common frame 640 through the paired common beams 648. Also, as illustrated in FIG. 10, each of the anchors 642 is supported on the glass substrate 626. Thus, the sensing structure 616 is floated within the inner space 612 and kept to be spaced away from the glass substrate 626, the enclosing wall 628, and the glass cap 630. In other words, in the sensing structure 616, the anchors 642 are the only portions that contact with the other components of the vibratory gyroscope 610. The reason why the paired beams are used for supporting each of the drive frames and the detection frames will be apparent from the following description.

In the sensing structure 616 so embodied, the drive beams 646a, 646b and as well as the drive frames 638a, 638b supported thereby have the configuration identical to each other. Therefore, when driven as will be described later, the drive frames 638a, 638b ideally oscillate about the drive oscillation center between the paired drive beams 646a, 646b at a resonance frequency in the opposite phases to each other where the relative phase shift is 180 degrees (so-called tuning-fork oscillation).

However, in practical, the configuration thereof such as shapes of the drive beams 646a, 646b, sizes and weights of the drive frames 638a, 638b are varied and unbalanced to each other due to the manufacturing tolerance. This causes the deviation between the resonance frequency determined by the drive frame 638a and the paired beams 646a supporting thereof, and the resonance frequency by the drive frame 38b and the paired beams 646b supporting thereof. Thus, when the drive frames 638a, 638b are driven to oscillate at the resonance frequency of one of the drive frames, the other one of the drive frames may oscillate with the phase shift deviated from the opposite phase of one of the drive frames.

According to the third embodiment, since the paired common beams 648 are used for connection among the detection frames 644a, 644b, the drive frames 638a, 638b, and the common frame 640, both of the drive frames 638a, 638b torsionally oscillate at the resonance frequency in the opposite phases without deviating therefrom, even if those frames and the beams supporting thereof have configuration and shape different from each other due to the manufacturing tolerance. In particular, the common beams 648 have torsional rigidity, cross section, and length designed to achieve the torsional oscillation of the drive frames 638a, 638b at the resonance frequency in the opposite phases. Thus, provision of the common beams 648 supporting the common frame 640 achieves the robust tuning-fork oscillation system that can oscillate at the common resonance frequency in the opposite phases in spite of the minor manufacturing tolerance.

The sensing structure 616 is made of conductive material and electrically connected to the ground potential (or a predetermined biasing potential). Each of the internal electrodes 618a, 618b, 620a, 620b, 622a, 622b, 624a, 624b has a main surface opposing and in parallel to the sensing structure 616 (see FIG. 10). Referring to FIG. 11, the layout and the function of the internal electrodes will be described hereinafter.

The internal electrodes 618a, 618b each are arranged on the glass substrate 626 opposing to and along the outer one of the sides (one side away from the anchor 642) of the drive frames 638a, 638b, which are applied with a given oscillation voltage (having AC voltage component on DC voltage component). The oscillation voltage effects an electrostatic force between the internal electrodes 618a, 618b and the outer sides of the drive frames 638a, 638b, which in turn oscillates the drive frames 638a, 638b about the drive beams 646a, 646b in the opposite phases, respectively.

For instance, as shown in FIG. 12B which is a cross sectional view along a line of D-D of FIG. 12A, the drive frame 638a is driven to torsionally oscillate about the drive beam 646a in a counterclockwise direction, while the drive frame 638b is driven to torsionally oscillate about the drive beam 646b in a clockwise direction. The torsional oscillation frequency corresponds to the frequency of the oscillation voltage, which is selected to be one of the resonance frequency of the oscillation system, allowing the resonance oscillation in the opposite phases.

Also, the internal electrodes 620a, 620b each are arranged on the glass substrate 626 opposing to and along the inner one of the sides (one side close to the anchor 42) of the drive frames 638a, 638b, for detecting the oscillation of the drive frames 638a, 638b about the drive beams 646a, 646b in the opposite phases, respectively. The internal electrodes 620a, 620b each define capacitance in conjunction with the drive frames 638a, 638b biased at the ground level, respectively. The capacitance varies in response to the oscillation (displacement) of the drive frames 638a, 638b, where the capacitance variation depends upon the variation of the oscillation amplitude of the drive frames 638a, 638b about the drive beams 646a, 646b.

The oscillation driver of the vibratory gyroscope 610 is structured to drive the drive frames 638a, 638b so that they oscillate about the drive beams 646a, 646b in the opposite phases, and the oscillation driver adjusts the oscillation frequency applied to the internal electrodes 618a, 618b based upon the detected capacitance (self-oscillation). The capacitance variation may be detected, for example, by a C/V (capacitance/voltage) converter (not shown). Also, the oscillation driver adjusts the oscillation voltage applied to the internal electrodes 618a, 618b so as to keep the oscillation amplitude substantially constant.

Two pairs of the internal electrodes 622a, 624a; 622b, 624b are arranged on the glass substrate 26 opposing to the detection frame 636a, 636b for detecting the motion, i.e., the oscillation about the detection beams 644a, 644b, of the detection frames 636a, 636b, respectively. As illustrated in FIG. 11, the internal electrodes 622a, 624a are symmetrically arranged relative to the X-axis, and also the internal electrodes 22b, 24b are symmetrically arranged relative to the X-axis. Similar to the detection of the oscillation about the drive beams 46a, 46b, the oscillation variation about the detection beams 44a, 44b are detected by the capacitance variation between the detection frames 36a, 36b and the internal electrodes 22a, 24a; 22b, 24b, respectively, which are converted to voltage variation detected by the C/V converter.

The internal electrodes 618a, 618b, 620a, 620b, 622a, 622b, 624a, 624b are electrically connected with a plurality of external electrodes through the wirings 660, 662, 664, 666, 670, 672, 674, respectively. For example, as shown in FIG. 9, the internal electrodes 618a, 618b are electrically connected with the external electrodes 676, 678 via a silicon layer, respectively. Like this, other internal electrodes 620a, 620b, 622a, 622b, 624a, 624b are electrically connected with the external electrodes 680, 682, 684, 686, 688, 690, respectively. The external electrodes 676, 678, 680, 682 from the internal electrodes 618a, 618b, 620a, 620b extend to the oscillation driver for electrical connection, while the external electrodes 684, 686, 688, 690 from the internal electrodes 622a, 622b, 624a, 624b are electrically connected with the oscillation driver.

The sensing structure 616 is electrically biased to the ground level through the external electrode 692. As described above, the oscillation driver is designed so as to apply a predetermined oscillation voltage to the internal electrodes 618a, 618b. Also, the oscillation driver detects the oscillation of the detection frames 636a, 636b based upon the voltage output from the C/V converter which detects the capacitance variation between the detection frames 36a, 36b and the internal electrodes 22a, 22b; 24a, 24b, respectively. Also, as will be described later, an angular-velocity calculator is provided for receiving the voltages corresponding to the detected oscillation of the detection frames 36a, 36b about the detection beams 44a, 44b.

The angular-velocity calculator calculates or detects the angular velocity based upon the voltages corresponding to the oscillation of the detection frames 636a, 636b about the detection beams 644a, 644b detected by the oscillation detector, which varies in response to the rotation of the vibratory gyroscope 610 around the Z-axis of the angular velocity, as will be described later.

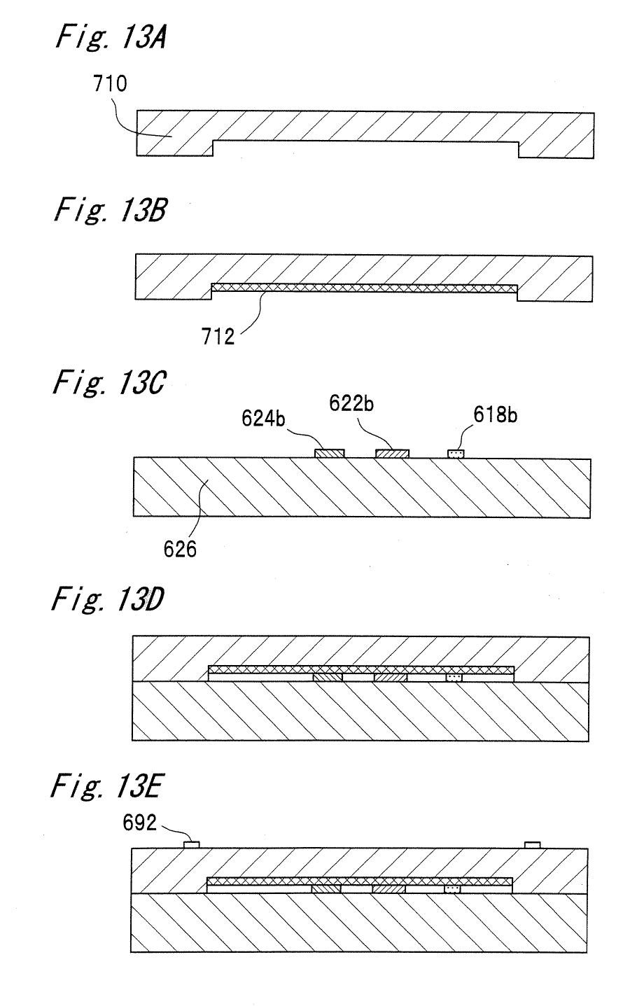

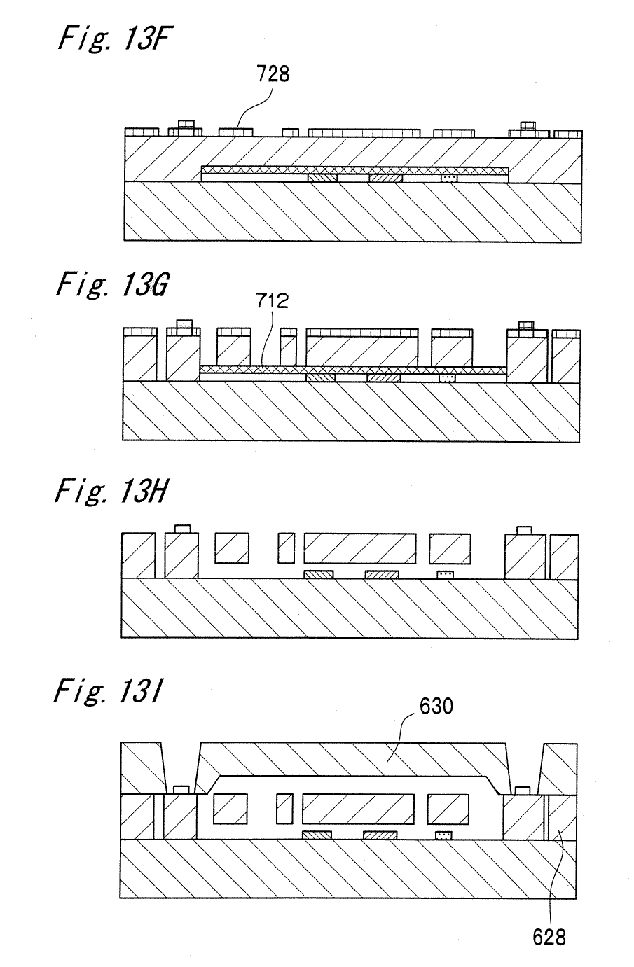

Next, the manufacturing process of the vibratory gyroscope 610 will be described herein, with reference to FIGS. 13A-13I, which are cross sectional views illustrating various steps for manufacturing the vibratory gyroscope 10 of the present embodiment.

Firstly, as shown in FIG. 13A, a wafer substrate 710 is etched with potassium hydroxide (KOH) for forming a stepped or recessed portion. Then, an oxide layer 712 is formed on the bottom surface of the recessed portion, which prevents over-etching by the ICP-RIE that is used at the later step.

On the other hand, as shown in FIG. 13C, a glass substrate 626 is prepared, and a plurality of internal electrodes 618b, 6622b, 624b is formed on the glass substrate 626. Although not illustrated in FIG. 13C, the other internal electrodes 618a, 620a, 620b, 622a, 624a and a plurality of wirings 660, 662, 664, 666, 668, 670, 672, 674 are also formed on the glass substrate 626 at predetermined positions. Those internal electrodes and wirings are formed by sputtering and depositing metal such as aluminum or gold at selective regions.

As illustrated in FIG. 13D, the wafer substrate 710 is bonded on the glass substrate 626 with the oxide layer 712 facing to the internal electrodes, by means of any conventional techniques such as an anodic bonding.

Next, as shown in FIG. 13E, the external electrode 692 is formed on the wafer substrate 710. Although not specifically illustrated, the other external electrodes 676, 678, 680, 682, 684, 686, 688, 690 are also formed on the wafer substrate 710 at predetermined positions.

As illustrated in FIG. 13F, an etching mask 728 is formed at predetermined regions for protecting the silicon substrate 710 when it is etched by the ICP-RIE. The etching mask 728 may be formed of material such as resist or aluminum.

As shown in FIG. 13G, the ICP-RIE technique is used for selectively etching the silicon substrate 710, where the silicon substrate 710 in the regions uncovered by the etching mask 728 is etched away. The remained portions of the silicon substrate 710 without being etched define the proof masses 634a, 634b and the enclosing wall 628 of the vibratory gyroscope 610.

Subsequently, as shown in FIG. 13H, the exposed oxide layer 712 are removed by hydrofluoric acid (HF) or buffered hydrofluoric acid (BHF). This separates the sensing structure 616 from the other components of the vibratory gyroscope 10 with exception of the anchors 642. Then, as shown in FIG. 13I, a glass cap 630 is bonded on the enclosing wall 628 under atmosphere pressure or vacuum environment to define the inner space 612 by means of the anodic bonding. To this end, the main body 614 of the vibratory gyroscope 610 is produced in accordance with the above-described manufacturing process.

Next, with reference to FIGS. 12A-12C, the operation of the vibratory gyroscope 610 of the third embodiment will be described herein. According to the sensing structure 616 of the vibratory gyroscope 610, the oscillation driver applies the oscillation voltage of a predetermined frequency to the internal electrodes 618a, 618b, for oscillating the drive frames 638a, 638b about the drive beams 646a, 646b, respectively, in the opposite phases to each other. It should be noted that the oscillation about the paired beams in the third embodiment refers to the oscillation about the oscillation center axes provided in the middle of the beams.

While the drive frames 638a, 638b are oscillating about the drive beams 646a, 646b, respectively, in the opposite phases, rotation of the vibratory gyroscope 610 around the Z-axis at the angular velocity generates the Coriolis force to induce the oscillation of the proof masses 634a, 634b about the detection beams 644a, 644b. In general, the Coriolis force is proportional to the angular velocity around the Z-axis of the proof mass and corresponds to the driving oscillation of the drive frame. Therefore, the induced oscillation of the detection frames 636a, 636b have the maximum amplitude in proportional to the angular velocity, and also have the frequency and the phase same as those of the drive frames 638a, 638b, respectively. Thus, the detection frames 636a, 636b are induced to oscillate at the resonance frequency in the opposite phases to each other. In FIG. 12B which is the cross sectional view along a D-D line of FIG. 12A, the detection frame 636a torsionally oscillates about the detection beam 644a in a counterclockwise direction, while the detection beam 644b torsionally oscillates about the detection beam 644b in a clockwise direction.

The induced oscillation about the detection beams 644a, 644b vary the capacitance between the detection frame 636a and the internal electrodes 622a, 624a, and between the detection frame 636b and the internal electrodes 622b, 624b. As the capacitance between the detection frame 636a and the internal electrode 622a increases, the capacitance between the detection frame 636a and the internal electrode 624a decreases, thus, the capacitance between the detection frame 636a and the internal electrodes 622a, 624a vary in the opposite phases. Such capacitance variation is detected by the C/V converter, which in turn outputs the voltage indicating the capacitance variation.

The voltages, which are output from the C/V converter indicating the capacitance variation between the detection frame 636a and the internal electrodes 622a and between the detection frame 636b and the internal electrodes 622b, are referred to as the voltages Va, Vb, respectively. Since the proof masses 634a, 634b are induced to oscillate about the detection beams 644a, 644b in the opposite phases, the voltages Va, Vb has a relationship as Va=−Vb. (Strictly speaking, the circuitry is designed such that the polarity of the voltages Va, Vb are opposite to each other.) Therefore, for example, by electrically connecting the internal electrodes 622a, 624b diagonally, the oscillation detector of the vibratory gyroscope 10 can output the voltage signal of Vout (=Va−Vb=2×Va=−2×Vb) to the angular-velocity calculator. Thus, double detection sensitivity can be obtained in comparison with the conventional vibratory gyroscope. Also, since the noise components in the same phase of the voltages Va, Vb are offset to each other, the signal-noise (S/N) ratio of the detection signal is improved. The angular-velocity calculator calculates the angular velocity of the vibratory gyroscope 610 based upon the phase of the driving oscillation and the voltage amplitude Vout of the induced oscillation. Therefore, the vibratory gyroscope 10 can precisely calculate the angular velocity at high sensibility, reducing the adverse effects of the disturbance oscillation.

One of examples showing the reduction of the disturbance oscillation will be described herein. When the vibratory gyroscope 610 receives the external force (disturbance oscillation) along the direction parallel to the Y-axis and/or the torsional oscillation about the X-axis, the detection frames 636a, 636b oscillate about the detection beams 44a, 44b, respectively, in the same phase. Thus, for example, in FIG. 12C of the cross sectional view along a line of E-E of FIG. 12A, both of the detection frames 636a, 636b torsionally oscillate about the detection beams 644a, 644b in a counterclockwise direction (same phase). Then, the voltages Va, Vb have the relationship, i.e., Va=Vb. Therefore, the voltage output from the oscillation detector is zero (0) volt. As above, the vibratory gyroscope 10 is designed such that the detection frames 636a, 636b are induced to oscillate about the detection beams 644a, 644b in the opposite phases, and the disturbance oscillation can hardly generate the induced oscillation in the opposite phases. Therefore, the angular velocity can precisely be detected, eliminating the possibility of improper detection.

One of the features of the vibratory gyroscope 610 will be described hereinafter in detail. As above, the detection frames, drive frames and common frame are each supported through the respective pair (two) of the torsional beams. Therefore, the vibratory gyroscope 610 likely eliminates the adverse impact of the disturbance oscillation especially characterized by lower oscillation frequency than those of the torsional oscillation of the drive frames and detection frames, and the other oscillation modes similar thereto. Typically, the torsional oscillation frequency of the drive frames and the detection frames are set to be greater than the frequency of the disturbance oscillation (e.g., 0 Hz to about 5 kHz), for reducing the impact of the disturbance oscillation. However, even though the resonance oscillation frequency of the those frames are designed to be 5 kHz or more, the vibratory gyroscope may be influenced by the oscillation of the frequency less than the resonance oscillation frequency because of the mechanical structure thereof.

For instance, in the sensing structure of FIG. 9, if the common frame is supported by a single common beam, obviously, the resonance frequency of the torsional oscillation of the common frame about the single beam extending along the Y direction is substantially lower than the resonance frequency of the oscillation modes of the drive and detection frames. This is because the resonance frequency of the oscillation is generally proportional to the square root of the beam rigidity (k) divided by the inertia moment (I) of the frame (\sqrt{0}(k/I)), and the inertia moment (I) of the common frame is much greater than those of the drive and detection frames.

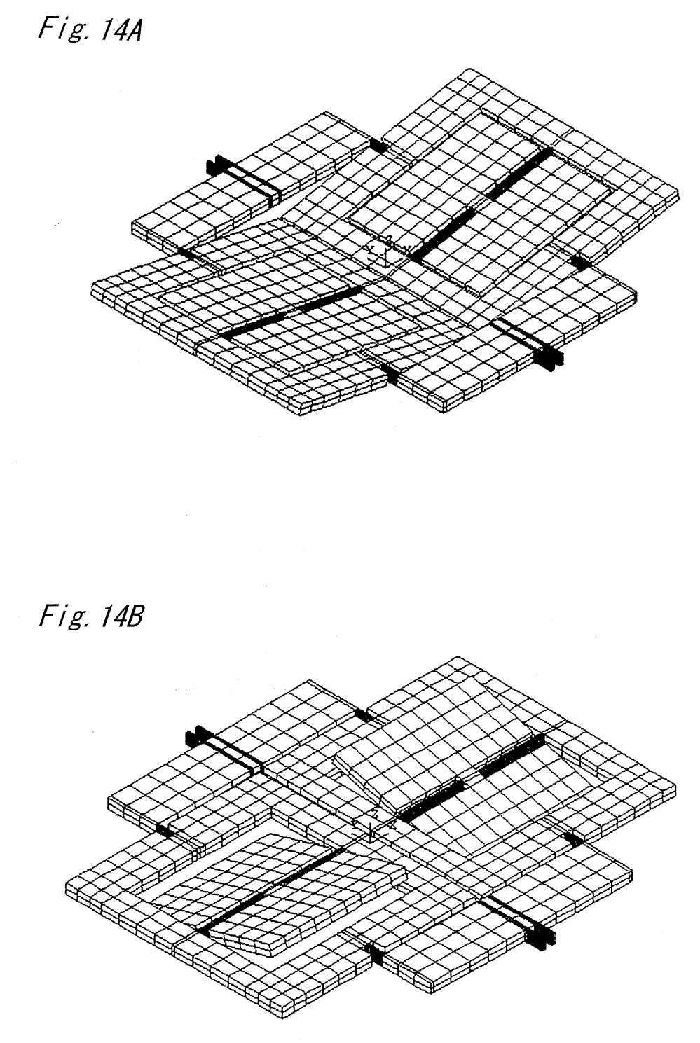

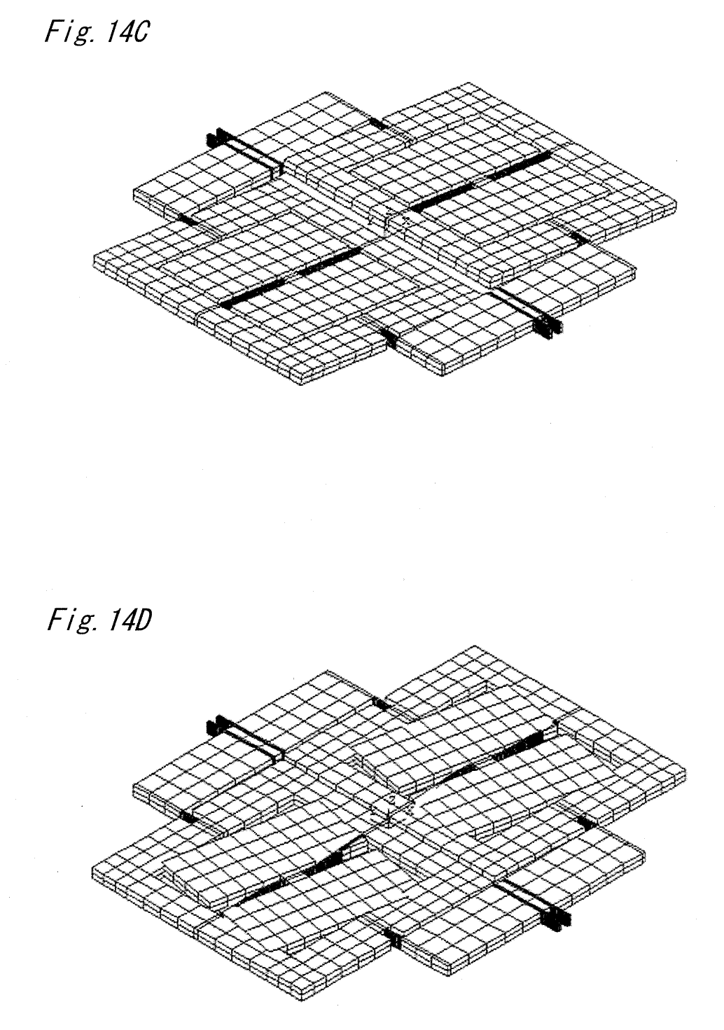

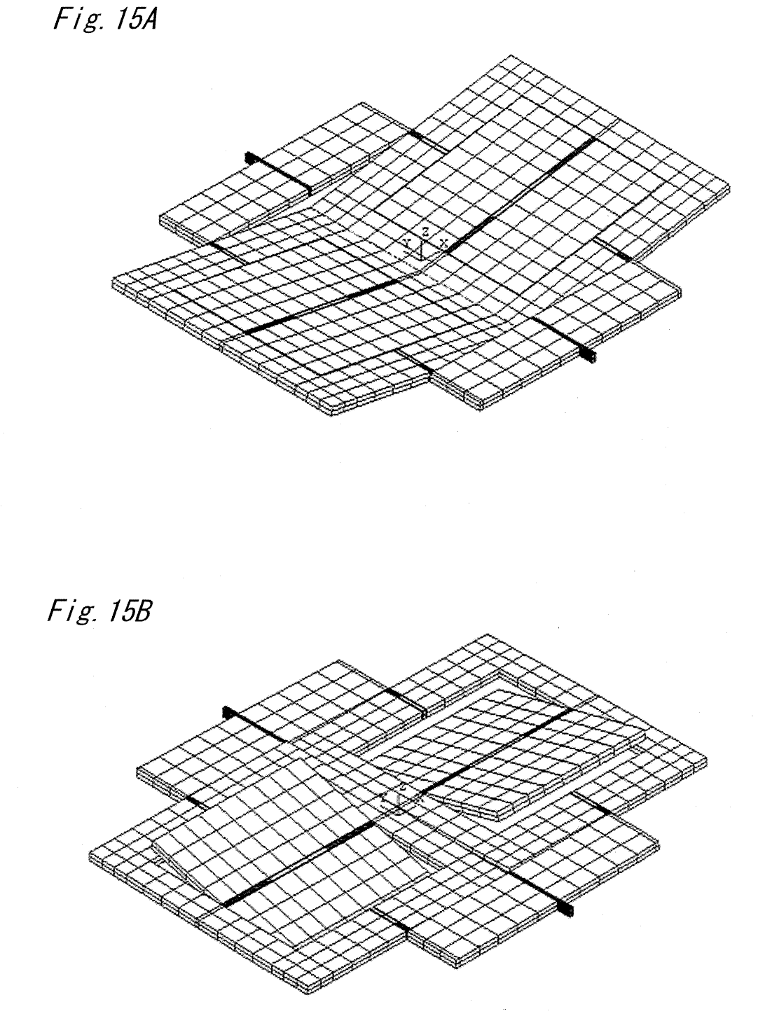

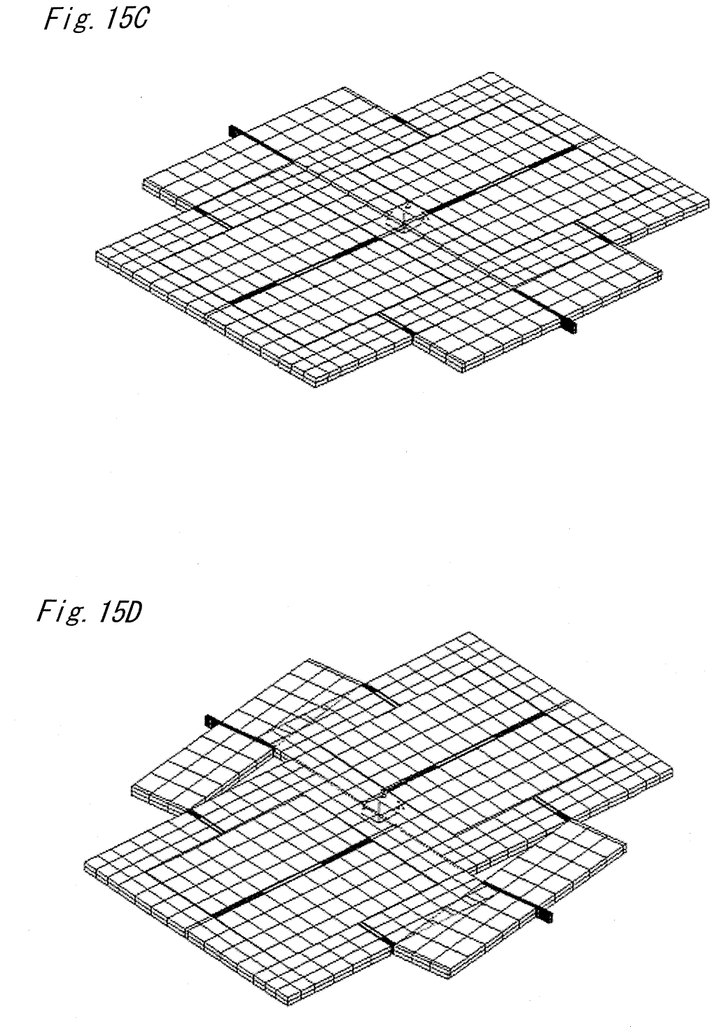

The resonance frequency of various oscillation modes will be described herein, with reference to FIGS. 14A-14D and 15A-15D illustrating exemplary analysis of those oscillation modes, using the drive frame of 2 mm square and the beams having thickness of 100 μm, width of 30 μm, and length of 175 μm. When the paired beams are used, the gap between the paired beams is set to 100 μm. FIGS. 14A-14D and 15A-15D are oblique views of the frames with the paired beams and with the single beam, respectively.

TABLE 1

| | Paired beams | Single beam |
|---|---|---|
| Mode | Frequency (FIG.) | Frequency (FIG.) |
| Drive Mode | 6,992 Hz (FIG. 14A) | 6,995 Hz (FIG. 15A) |
| Detection Mode | 7,197 Hz (FIG. 14B) | 7,037 Hz (FIG. 15B) |
| Total Torsion Mode | 5,439 Hz (FIG. 14C) | 2,579 Hz (FIG. 15C) |
| In-plane Torsion Mode | 10,204 Hz (FIG. 14B) | 5,348 Hz (FIG. 15D) |

As shown in Table 1, when the single beam is used, the sensing structure has the total torsion mode and the in-plane torsion mode having the resonance frequency less than those of the driving oscillation and the detection oscillation. In particular, while the drive mode (FIG. 15A) and the detection mode (FIG. 15B) have the resonance frequency of about 7 kHz, the total torsion mode has the resonance frequency of about 2.5 kHz (FIG. 15C). Thus, the sensing structure is more likely influenced by the disturbance oscillation having the lower frequency, resulting in the adverse impact on detection of the angular velocity. While it may be possible to increase the resonance frequency of the total torsion mode by making the single beam thicker for improving the rigidity thereof, this may cause another problem, that is, the phase is deviated from one of the tuning-fork oscillation.

Contrary, the oscillating structure (FIGS. 14A-14D) having the paired beams can eliminates the adverse effects by the disturbance oscillation, since the resonance frequency of the drive mode, the detection mode, and the other modes can advantageously be set greater than the frequency of the disturbance oscillation which likely affects the adverse effect.

Also, the resonance oscillation of the bending oscillation in the direction along the Z-axis can be increased by provision of the paired beams rather than use of the single beam. Further, the oscillation of the torsional rotation about the Z-axis can be reduced (that is, the resonance frequency of the torsional oscillation mode can be increased), thereby preventing the adverse effect of the disturbance oscillation.

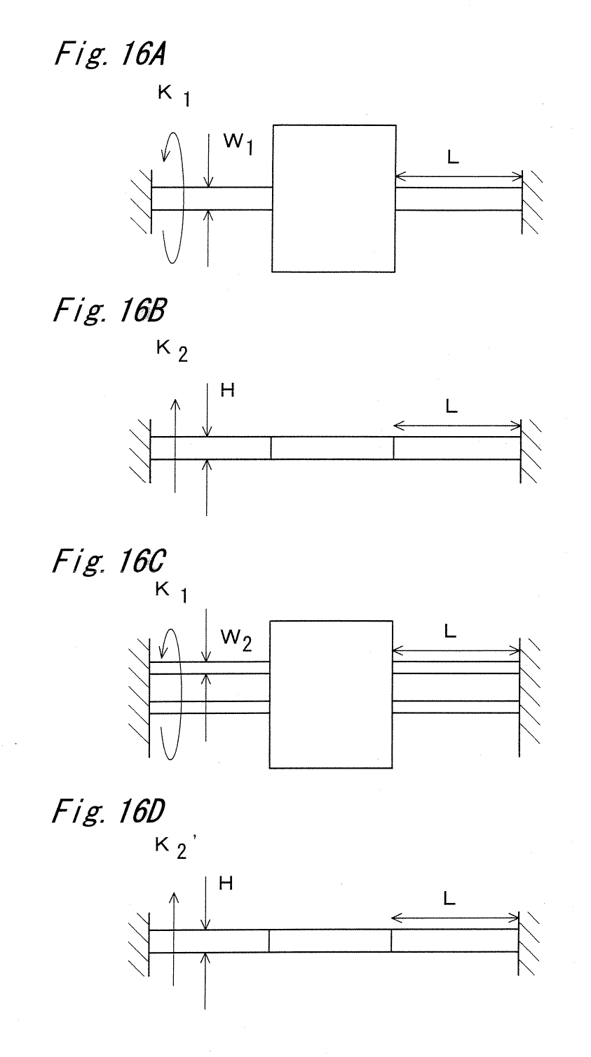

The bending oscillation in the direction along the Z-axis can be formulated with parameters, indicated in FIGS. 16A-16D, including torsional rigidity K1, out-of-plane rigidity K2 (rigidity along the Z-axis), width W1, and lateral elastic coefficient H of the beam. Frames having a single beam and a pair of beams are illustrated in FIG. 16A-16B, and 16C-16D, respectively. The torsional rigidity K1 is proportional to the third power of the beam width W1 can be expressed as follows (although not so simply proportional in practical due to the shape of the cross section).

$$\begin{matrix}{K}_{1} \approx \frac{2}{3} \frac{{GHW}_{1}^{3}}{L} & H >> W 1\end{matrix} \qquad ( 1 )$$

wherein G and H represent the lateral elastic coefficient and the thickness of the beam, respectively.

Also, the out-of-plane rigidity K2 is expressed by the following formula.

$${K}_{2} = \frac{2 {H}^{3} {EW}_{1}}{{L}^{3}} \qquad ( 2 )$$

When the torsional rigidity K1 is remained the same and two of the beams are provided, the beam width W2 can be expressed by following formula.

$${W}_{2} = {2}^{- \frac{1}{3}} {W}_{1} \qquad ( 3 )$$

In this case, the out-of-plane rigidity K2′ can be expressed as follows.

$${K}_{2} = 2 \times \frac{2 {H}^{3} {EW}_{2}}{{L}^{3}} = {2}^{\frac{2}{3}} {K}_{2} = 1.5847 {K}_{2} \qquad ( 4 )$$

Therefore, the resonance frequency of the bending oscillation along the Z-axis when using the paired beams can substantially be increased, i.e., 1.6 times higher than that with the single beam. This magnification ratio (MR) is increased as the number of the provided beams, and can be expressed as follows.

$$MR = {n}^{\frac{2}{3}} \qquad ( 5 )$$

wherein n stands for the number of beams.

In FIGS. 14A-14D, and 15A-15D showing the analysis, while use of the single beam causes the out-of-plane rigidity of about 10 kHz, the present embodiment achieve the out-of-plane rigidity of about 15 kHz. This result confirms the above-described formulation.

As above, although the present invention is described with the foregoing (three) embodiments, it is not limited thereto, rather can cover any other structures without departing from the splits and scopes of the present invention.

For example, in the first to third embodiments, although the torsional counterforce of the beams is used for torsional oscillation of the proof masses, any other forces may be used for torsional oscillation, as long as two of the proof masses oscillate in the opposite phases.

Also, even when the electrostatic force is used, it is generated in the direction parallel to the Z-axis in the first and third embodiments and in the direction parallel to the X-axis in the second embodiment. The direction of the electrostatic force is not critical as far as the drive frames are driven to torsionally oscillate about the drive beams.

In addition to the electrostatic force, any other type of forces such as electromagnetic force may be used for driving to oscillate the drive frames. In this case, the main body of the vibratory gyroscope may be provided with electromagnets and the drive frames may be formed of conductive metal material so that electromagnetic force (Lorentz force) can be generated therebetween for driving the oscillation.

What is claimed is:

1. A vibratory gyroscope, comprising:
a pair of proof masses having the same inertia mass, each of said proof masses having a first axis, said proof masses arranged symmetrically in relation to a second axis;
a pair of drive elements, each of said drive elements having a driving axis extending in parallel to the second axis and supporting respective one of said proof masses to allow oscillation thereof about the first axis;
a supporting element with an anchor element for supporting said drive elements to allow oscillation thereof about the driving axes; and
a main body having an inner space for receiving said supporting element, said main body being in contact with the anchor element of said supporting element and spaced away from said proof masses and said drive elements.

2. The vibratory gyroscope according to claim 1,
wherein each of said proof masses includes a first frame having a first beam extending along the first axis and connecting with respective one of said drive elements, for allowing oscillation thereof about the first beam;
wherein each of said drive elements includes a second frame having a second beam extending along the driving axis and connecting with said main body, for allowing oscillation thereof about the second beam; and
wherein said main body includes a third frame connected to the second beam, and a third beam extending along the second axis and connecting with the anchor element of said supporting element.

3. The vibratory gyroscope according to claim 2,
wherein at least one of the first, second, and third beams includes a plurality of beams extending in parallel.

4. The vibratory gyroscope according to claim 1,
wherein each of said proof masses includes a first frame having a pair of first beams extending in parallel along the first axis and connecting with respective one of said drive elements, for allowing oscillation thereof about a first center axis between the first beams;
wherein each of said drive elements includes a second frame having a pair of second beams extending in parallel along the driving axis and connecting with said main body, for allowing oscillation thereof about a second center axis between the second beams; and
wherein said main body includes a third frame connected to the second beam, and a pair of third beams extending in parallel along the second axis and connecting with the anchor element of said supporting element.

5. The vibratory gyroscope according to claim 1,
wherein a pair of means for driving said drive elements is provided for oscillation of said drive elements about the driving axes, each of said drive elements being biased at a predetermined potential.

6. The vibratory gyroscope according to claim 5,
wherein each of the driving means includes an internal electrode on said main body, opposing to respective one of said drive elements.

7. The vibratory gyroscope according to claim 5,
wherein each of the driving means includes a comb electrode and a comb structure having planer comb-like shape, which opposes to each other and are provided on said main body and on said drive elements, respectively.

8. The vibratory gyroscope according to claim 1, further comprising:
an oscillation driver for driving said drive elements for oscillation about the driving axes at a predetermined frequency in opposite phases to each other;
an oscillation detector for detecting the oscillation of said proof masses about the first axis; and
an angular-velocity calculator for calculating an angular velocity of the vibratory gyroscope around a third axis perpendicular both to the first and second axes, based upon the oscillation of said proof masses detected by said oscillation detector.

9. The vibratory gyroscope according to claim 8, further comprising:
a pair of internal electrodes on said main body, each of the internal electrodes opposing to respective one of said drive elements, each of said drive elements being biased at a predetermined potential;
wherein said oscillation driver applies a predetermined alternate voltage on the internal electrodes at a predetermined frequency in opposite phases to each other.

10. The vibratory gyroscope according to claim 8, further comprising:
a pair of comb electrodes and comb structures opposing to each other, each of the comb electrodes and the comb structures being provided on said main body and on said drive elements, respectively;
wherein said oscillation driver applies a predetermined alternate voltage between the each one of the comb electrodes and respective one of the comb structures, at a predetermined frequency in opposite phases to each other.

11. The vibratory gyroscope according to claim 1, further comprising:
an oscillation detector for detecting the oscillation of said proof masses about the first axis; and
an acceleration calculator for calculating acceleration along the second axis, based upon the oscillation of said proof masses detected by said oscillation detector.

12. The vibratory gyroscope according to claim 1,
wherein said proof masses, said drive elements, and said supporting element are formed of silicon substrate.
